(19) United States
(12) Patent Application Publication
(10) Pub. No.: US 2026/0022005 A1
(43) Pub. Date: Jan. 22, 2026

(54) BEVERAGE SERVER AND POURING NOZZLE

(71) Applicant: ASAHI GROUP HOLDINGS, LTD., Tokyo (JP)

(72) Inventors: Shinsuke MITSUHATA, Moriya-shi (JP); Toshikazu Hamaura, Sousa-shi (JP); Hiroyuki Takahashi, Sousa-shi (JP)

(73) Assignee: ASAHI GROUP HOLDINGS, LTD., Tokyo (JP)

(21) Appl. No.: 19/340,717

(22) Filed: Sep. 25, 2025

Related U.S. Application Data
(63) Continuation of application No. PCT/JP2024/002710, filed on Jan. 29, 2024.

(30) Foreign Application Priority Data
Mar. 30, 2023 (JP) 2023-056272

(51) Int. Cl. B67D 1/12

(52) U.S. Cl. CPC B67D 1/1202

(57) ABSTRACT

A beverage server configured to pour a carbonated beverage to a beverage container, includes a supply source configured to supply the carbonated beverage; and a pouring nozzle configured to pour the carbonated beverage supplied from the supply source to the beverage container, wherein the pouring nozzle includes a cylindrical member, and a guide including a guide surface whose one portion is arranged inside the cylindrical member and whose another portion projects to a lower side of the cylindrical member, the carbonated beverage runs down inside the cylindrical member while being guided by the guide surface, and the guide surface includes an upper end and a lower end and is formed such that a tilt becomes moderate from a position between the upper end and the lower end to the lower end.

### CROSS-REFERENCE TO RELATED APPLICATIONS

This application claims priority to and the benefit of Japanese Patent Application No. 2023-056272 filed on Mar. 30, 2023, and PCT Application No. PCT/JP2024/002710 filed on Jan. 29, 2024, the entire disclosures of which are incorporated herein by reference.

### BACKGROUND OF THE INVENTION

### Field of the Invention

The present invention relates to a beverage server and a pouring nozzle.

### Description of the Related Art

There is known a beverage server that spouts a carbonated beverage such as carbonated water. For example, a beverage server configured to pour a carbonated beverage whose gas volume (to be referred to as GV hereinafter) value exceeds 4.0 is required to pour a carbonated beverage to a beverage container while suppressing foaming. This is because it is important for such a carbonated beverage to maintain a high GV after pouring of the beverage to the beverage container.

### CITATION LIST

### Patent Literature

PTL 1: Japanese Patent Laid-Open No. 2015-124006

### SUMMARY OF INVENTION

It is an object of the present invention to provide a technique advantageous for pouring a carbonated beverage while suppressing foaming at the time of pouring and maintaining a high GV.

A first aspect of the present invention is directed to a beverage server configured to pour a carbonated beverage to a beverage container, and the beverage server comprises: a supply source configured to supply the carbonated beverage; and a pouring nozzle configured to pour the carbonated beverage supplied from the supply source to the beverage container, wherein the pouring nozzle includes a cylindrical member, and a guide including a guide surface whose one portion is arranged inside the cylindrical member and whose another portion projects to a lower side of the cylindrical member, the carbonated beverage runs down inside the cylindrical member while being guided by the guide surface, and the guide surface includes an upper end and a lower end and is formed such that a tilt becomes moderate from a position between the upper end and the lower end to the lower end.

A second aspect of the present invention is directed to a pouring nozzle configured to pour, to a beverage container, a carbonated beverage supplied from a supply source configured to supply the carbonated beverage, and the pouring nozzle includes a cylindrical member, and a guide including a guide surface whose one portion is arranged inside the cylindrical member and whose another portion projects to a lower side of the cylindrical member, the carbonated beverage runs down inside the cylindrical member while being guided by the guide surface, and the guide surface includes an upper end and a lower end and is formed such that a tilt becomes moderate from a position between the upper end and the lower end to the lower end.

According to the present invention, there is provided a technique advantageous for pouring a carbonated beverage while suppressing foaming at the time of pouring and maintaining a high GV.

### BRIEF DESCRIPTION OF DRAWINGS

FIG. 1 is a view showing the configuration of a beverage server according to an embodiment;

FIG. 2A is a view showing the configuration of a pouring nozzle according to the first configuration example;

FIG. 2B is a view showing the configuration of the pouring nozzle according to the first configuration example;

FIG. 2C is a view showing the configuration of the pouring nozzle according to the first configuration example;

FIG. 3A is a view showing the configuration of a pouring nozzle according to the second configuration example;

FIG. 3B is a view showing the configuration of the pouring nozzle according to the second configuration example;

FIG. 3C is a view showing the configuration of the pouring nozzle according to the second configuration example;

FIG. 4A is a view showing the configuration of a pouring nozzle according to the third configuration example;

FIG. 4B is a view showing the configuration of the pouring nozzle according to the third configuration example;

FIG. 4C is a view showing the configuration of the pouring nozzle according to the third configuration example;

FIG. 5A is a view showing the configuration of a pouring nozzle according to the fourth configuration example;

FIG. 5B is a view showing the configuration of the pouring nozzle according to the fourth configuration example;

FIG. 6A is a view showing the configuration of a pouring nozzle according to the fifth configuration example;

FIG. 6B is a view showing the configuration of the pouring nozzle according to the fifth configuration example;

FIG. 7A is a view showing the configuration of a pouring nozzle according to the sixth configuration example;

FIG. 7B is a view showing the configuration of the pouring nozzle according to the sixth configuration example;

FIG. 8A is a view showing the configuration of a pouring nozzle according to the seventh configuration example;

FIG. 8B is a view showing the configuration of the pouring nozzle according to the seventh configuration example;

FIG. 8C is a view showing the configuration of the pouring nozzle according to the seventh configuration example;

FIG. 9 is a view schematically showing the effect of the embodiment; and

FIG. 10 is a view schematically showing the effect of the embodiment.

### DESCRIPTION OF EMBODIMENTS

The embodiments will now be described in detail with reference to the accompanying drawings. Note that the embodiments described below are not intended to limit the scope of the invention claimed in the claims, and not all combinations of features described in the embodiments are necessarily essential to the invention. Two or more of the features described in the embodiments may be arbitrarily combined. Furthermore, the same or similar configurations are assigned the same reference numbers, and duplicate descriptions are omitted.

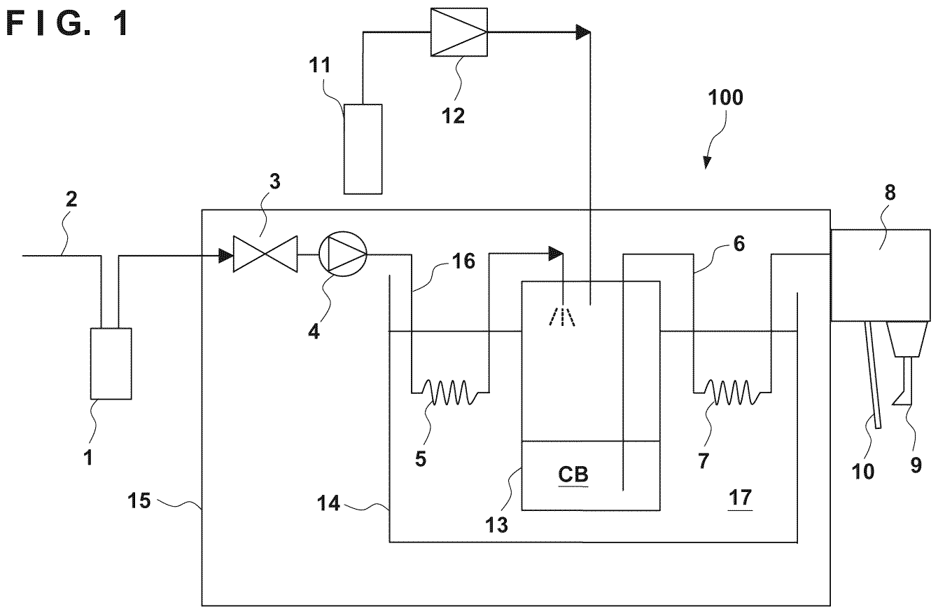

FIG. 1 schematically shows the configuration of a beverage server 100 according to an embodiment of the present invention. The beverage server 100 can include a main body portion 15 that is a supply source for supplying a carbonated beverage CB, and a pouring nozzle 9 that pours the carbonated beverage CB supplied from the main body portion 15 to a beverage container (not shown). The beverage server 100 can include a pouring head 8 projecting from the main body portion 15, and the pouring nozzle 9 can form a part of the pouring head 8. The beverage container may be, for example, a container to which a lid can be attached (for example, a water bottle) or a container to which a lid cannot be attached (for example, a tumbler), and it is not limited to a specific one.

A beverage can be supplied to the beverage server 100 via a channel 2. The beverage supplied to the beverage server 100 may be water or a beverage other than water. In another viewpoint, the beverage supplied to the beverage server 100 may be a beverage to which a carbon dioxide gas is added or may be a carbonated beverage to which a carbon dioxide gas is added. In still another viewpoint, the beverage supplied to the beverage server 100 may be an alcoholic beverage or may be a non-alcoholic beverage.

A filter 1 may be arranged in the channel 2. The main body portion 15 can include a channel 16 connected to the channel 2. A valve 3 and a pump 4 can be provided in the channel 16. The main body portion 15 can include an adding unit (carbonator) 13 that generates the carbonated beverage CB by adding a carbon dioxide gas to the beverage supplied to the main body portion 15. The beverage can be supplied to the adding unit 13 via the channel 16. The adding unit 13 can be configured to dissolve the carbon dioxide gas supplied from a carbon dioxide gas supply source (for example, a carbon dioxide gas cylinder) 11 in the beverage. The carbon dioxide gas can be supplied from the carbon dioxide gas supply source 11 to the adding unit 13 via a pressure reduction valve 12.

The main body portion 15 may include a cooling tank 14. The adding unit 13 is cooled by a coolant 17 such as water in the cooling tank 14, and the carbonated beverage CB can thus be cooled. The channel 16 may include a cooling coil 5 immersed in the coolant 17. The carbonated beverage CB generated by the adding unit 13 can be supplied to the pouring head 8 (pouring nozzle 9) via a channel 6. The channel 6 may include a cooling coil 7 immersed in the coolant 17.

In the pouring head 10, a positioning member 10 configured to position the beverage container (not shown) can be provided. A user can position the beverage container by pressing the beverage container against the positioning member 10. In this state, it is preferable that the mouth portion of the beverage container and the pouring head 10 are not in contact in the sanitary viewpoint.

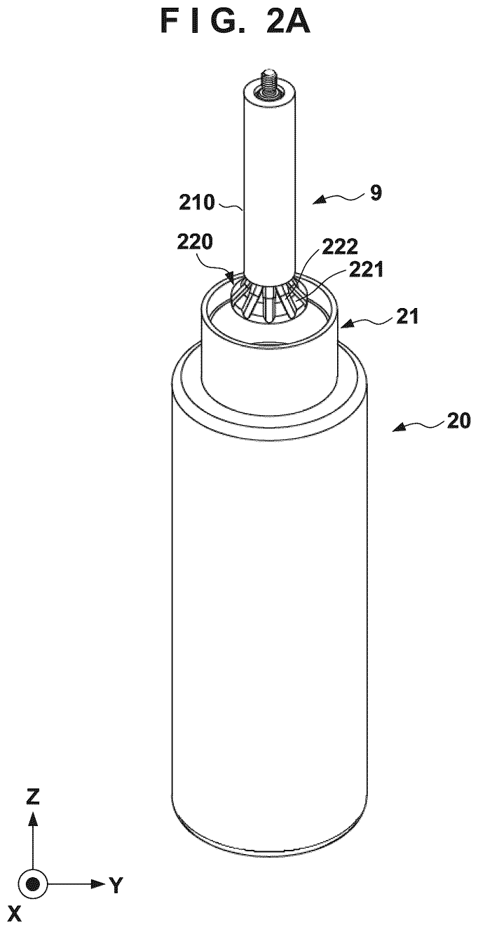

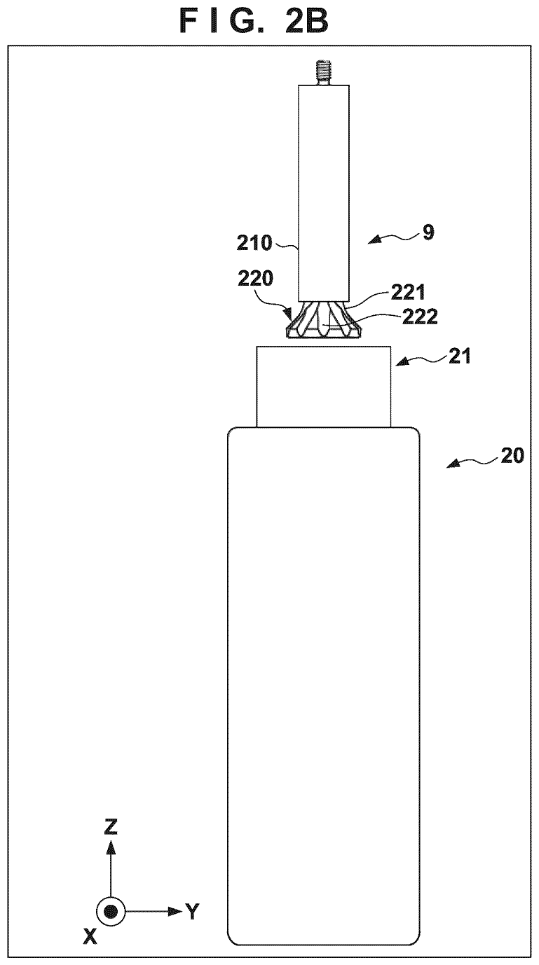

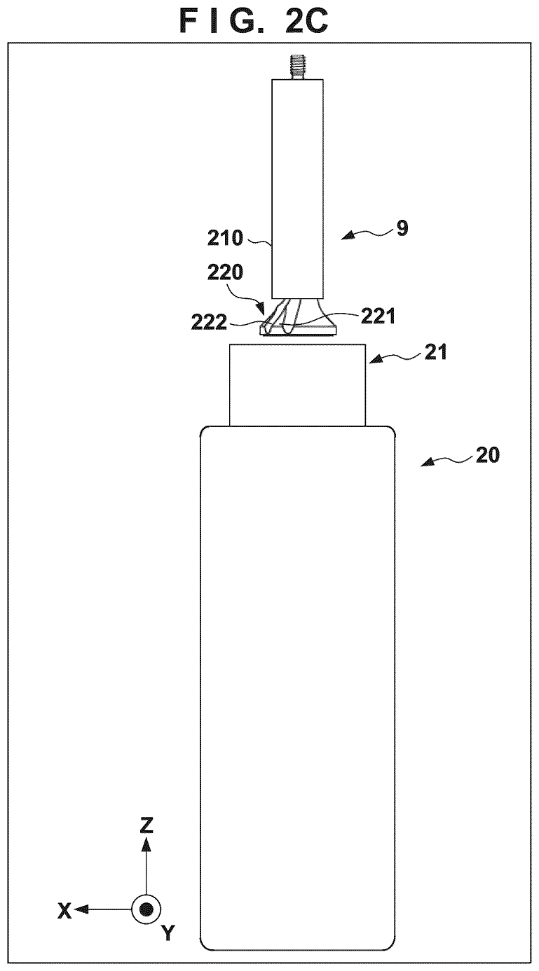

FIGS. 2A, 2B, and 2C show the pouring nozzle 9 according to the first configuration example together with a beverage container 20 with a mouth portion 21. The pouring nozzle 9 can include a cylindrical member 210 and a guide 220. The guide 220 includes a guide surface 221. One portion of the guide surface 221 is arranged inside the cylindrical member 210, and another portion (lower portion) of the guide surface 221 projects to the lower side of the cylindrical member 210. The carbonated beverage poured from the pouring nozzle 9 runs down inside the cylindrical member 210 while being guided by the guide surface 221. The guide surface 221 includes an upper end and a lower end and can be formed such that the tilt becomes moderate from a position between the upper end and the lower end to the lower end. The tilt can smoothly change. The guide surface 221 can be formed such that the carbonated beverage that has passed the lower end spreads in a fan shape. In another viewpoint, the guide surface 221 can be formed such that the carbonated beverage that has passed the lower end radially spreads. The guide surface 221 can include a plurality of grooves 222 provided to control the flow of the carbonated beverage. The maximum size of the lower end of the guide surface 221 in a direction along a plane orthogonal to the axial direction of the cylindrical member 210 is larger than the maximum size (in this example, the outer diameter) of the cylindrical member in the direction along the plane.

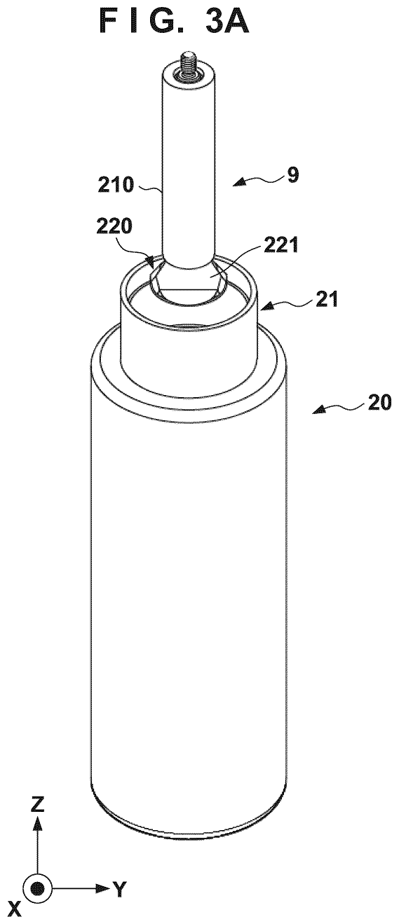

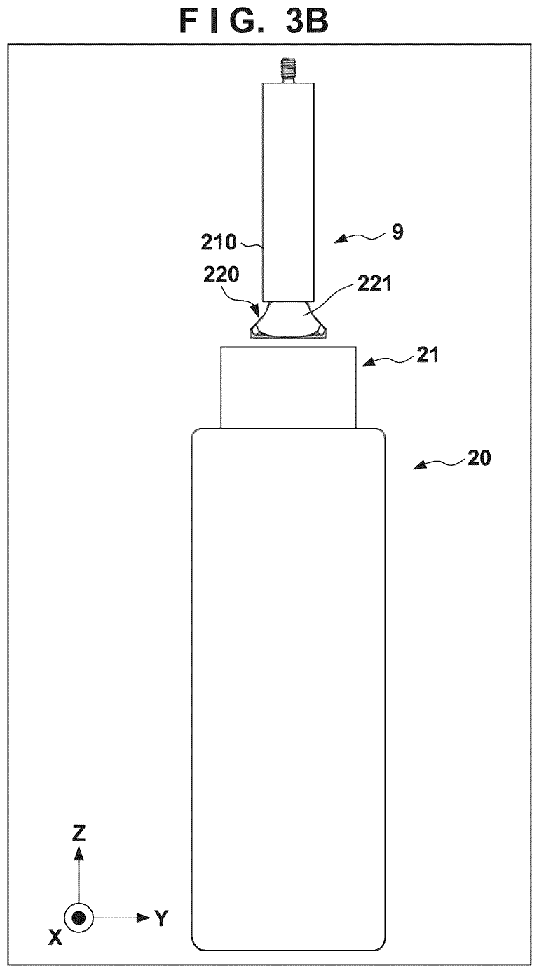

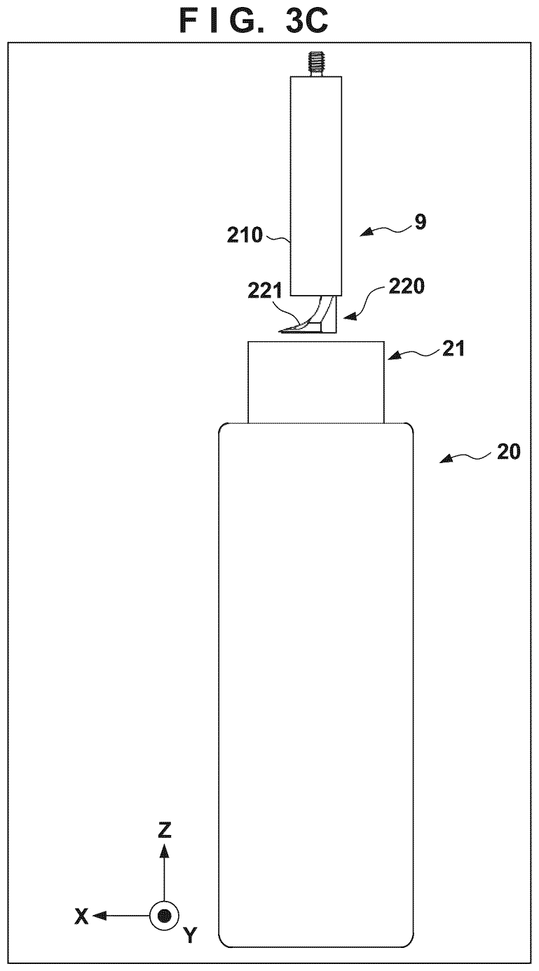

FIGS. 3A, 3B, and 3C show the pouring nozzle 9 according to the second configuration example together with the beverage container 20 with the mouth portion 21. The pouring nozzle 9 can include the cylindrical member 210 and the guide 220. The guide 220 includes the guide surface 221. One portion of the guide surface 221 is arranged inside the cylindrical member 210, and another portion (lower portion) of the guide surface 221 projects to the lower side of the cylindrical member 210. The carbonated beverage poured from the pouring nozzle 9 runs down inside the cylindrical member 210 while being guided by the guide surface 221. The guide surface 221 includes an upper end and a lower end and can be formed such that the tilt becomes moderate from a position between the upper end and the lower end to the lower end. The tilt can smoothly change. The guide surface 221 can be formed such that the carbonated beverage that has passed the lower end spreads in a fan shape. In another viewpoint, the guide surface 221 can be formed such that the carbonated beverage that has passed the lower end radially spreads. In the second configuration example, no grooves are provided in the guide surface 221. The maximum size of the lower end of the guide surface 221 in a direction along a plane orthogonal to the axial direction of the cylindrical member 210 is larger than the maximum size (in this example, the outer diameter) of the cylindrical member in the direction along the plane.

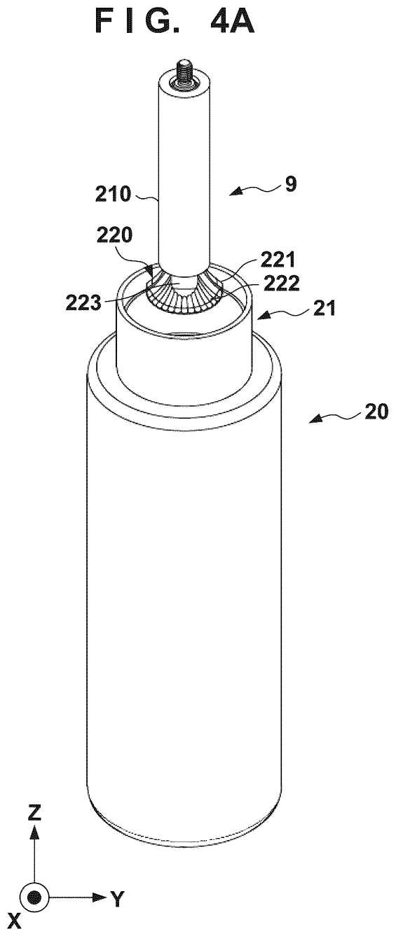

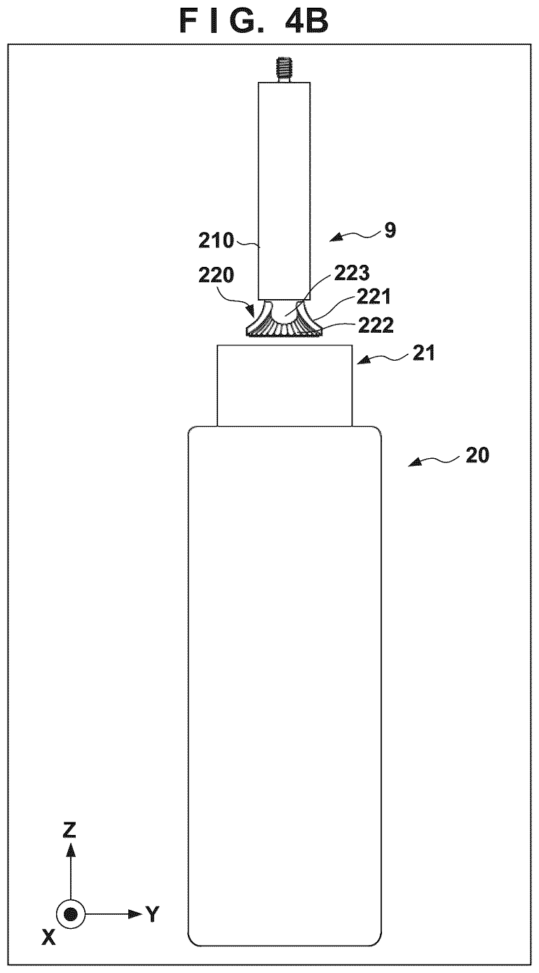

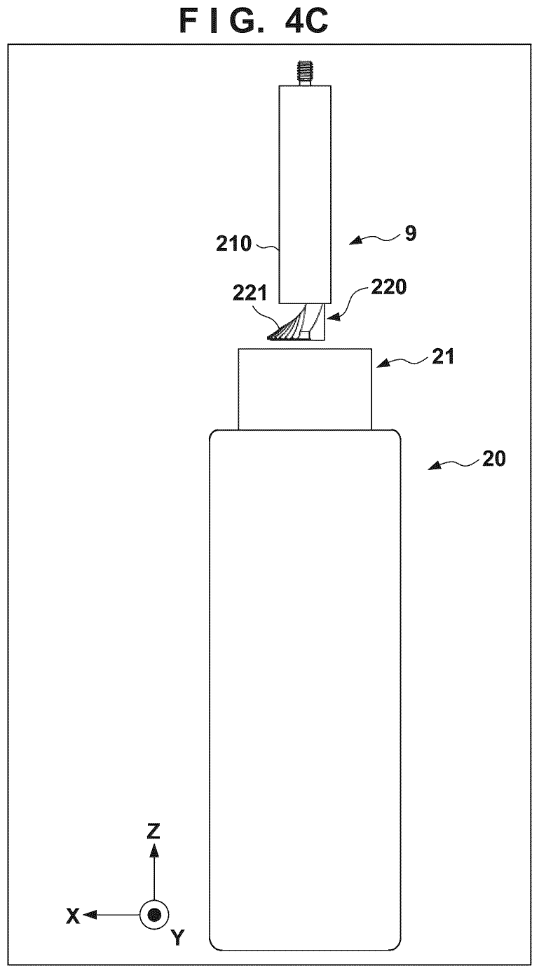

FIGS. 4A, 4B, and 4C show the pouring nozzle 9 according to the third configuration example together with the beverage container 20 with the mouth portion 21. The pouring nozzle 9 can include the cylindrical member 210 and the guide 220. The guide 220 includes the guide surface 221. One portion of the guide surface 221 is arranged inside the cylindrical member 210, and another portion (lower portion) of the guide surface 221 projects to the lower side of the cylindrical member 210. The carbonated beverage poured from the pouring nozzle 9 runs down inside the cylindrical member 210 while being guided by the guide surface 221. The guide surface 221 includes an upper end and a lower end and can be formed such that the tilt becomes moderate from a position between the upper end and the lower end to the lower end. The tilt can smoothly change. The guide surface 221 can be formed such that the carbonated beverage that has passed the lower end spreads in a fan shape. In another viewpoint, the guide surface 221 can be formed such that the carbonated beverage that has passed the lower end radially spreads. The guide surface 221 can include the plurality of grooves 222 provided to control the flow of the carbonated beverage. The guide surface 221 includes a first region 223 without grooves, and a second region from the first region 223 to the lower end of the guide surface 221, and the plurality of grooves 222 can be provided in the second region. The maximum size of the lower end of the guide surface 221 in a direction along a plane orthogonal to the axial direction of the cylindrical member 210 is larger than the maximum size (in this example, the outer diameter) of the cylindrical member in the direction along the plane.

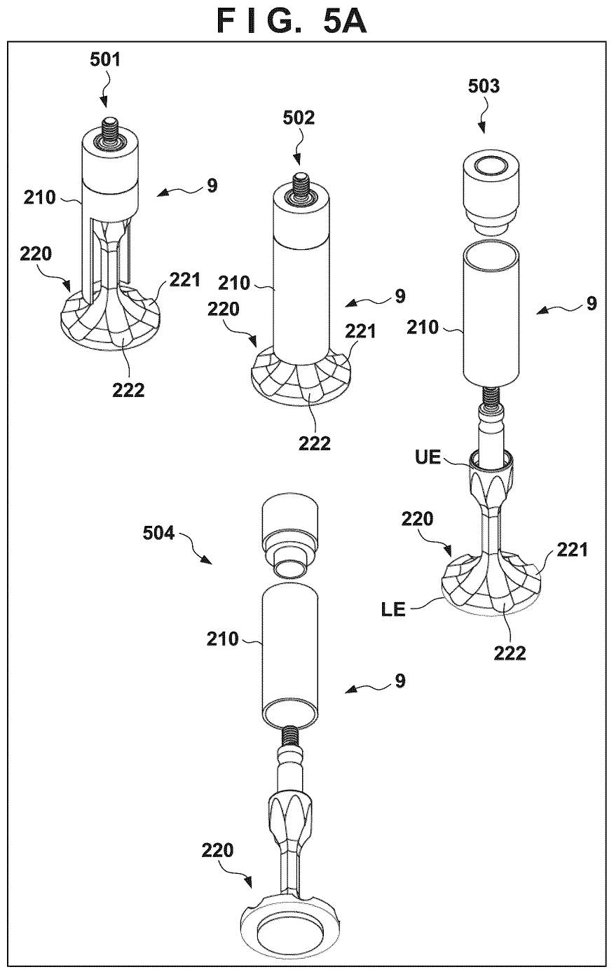

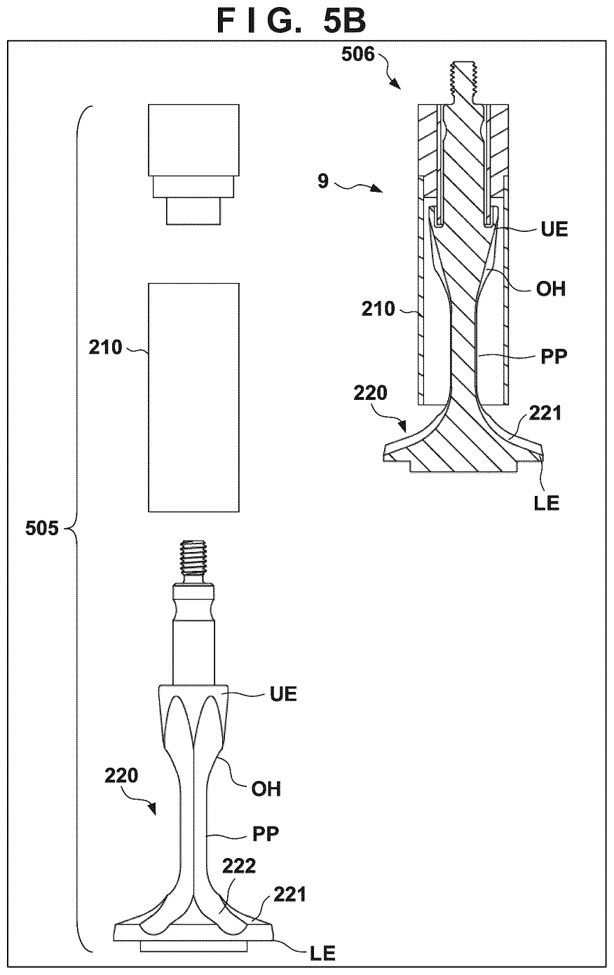

FIGS. 5A and 5B show the pouring nozzle 9 according to the fourth configuration example. Reference numeral 501 indicates a perspective view of the pouring nozzle 9 with a partially cutaway view of the cylindrical portion 210. Reference numeral 502 indicates a perspective view of the pouring nozzle 9. Reference numerals 503 and 504 indicate exploded perspective views of the pouring nozzle 9. Reference numeral 505 indicates an exploded front view of the pouring nozzle 9. Reference numeral 506 indicates a sectional view of the pouring nozzle 9. The pouring nozzle 9 can include the cylindrical member 210 and the guide 220. The guide 220 includes the guide surface 221. One portion of the guide surface 221 is arranged inside the cylindrical member 210, and another portion (lower portion) of the guide surface 221 projects to the lower side of the cylindrical member 210. The carbonated beverage poured from the pouring nozzle 9 runs down inside the cylindrical member 210 while being guided by the guide surface 221. The guide surface 221 includes an upper end UE and a lower end LE and can be formed such that the tilt becomes moderate from a position PP between the upper end UE and the lower end LE to the lower end LE. The tilt can smoothly change. The guide surface 221 can be formed such that the carbonated beverage that has passed the lower end LE spreads in a fan shape. In another viewpoint, the guide surface 221 can be formed such that the carbonated beverage that has passed the lower end LE radially spreads. The guide surface 221 can include the plurality of grooves 222 provided to control the flow of the carbonated beverage. The width of the plurality of grooves in the direction orthogonal to the axial direction of the cylindrical member 210 falls within the range of, for example, 1 to 5 mm, and preferably within the range of 2 to 3 mm. The guide surface 221 can include an overhang surface OH in the section from the upper end UE to the position PP between the upper end UE and the lower end LE. The overhang surface OH can wholly be located inside the cylindrical member 210. The overhang surface OH is advantageous for controlling the flow velocity of the carbonated beverage.

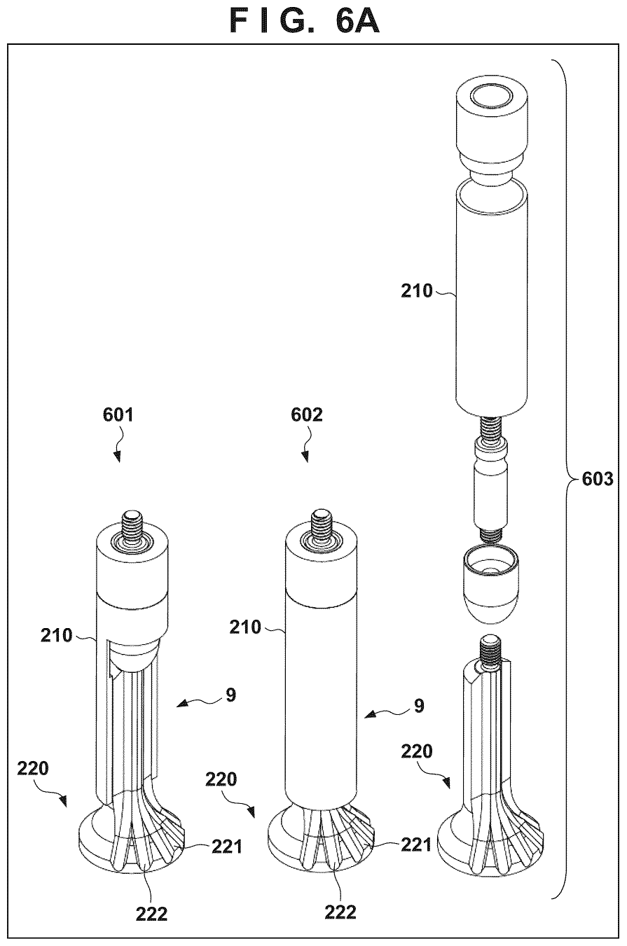

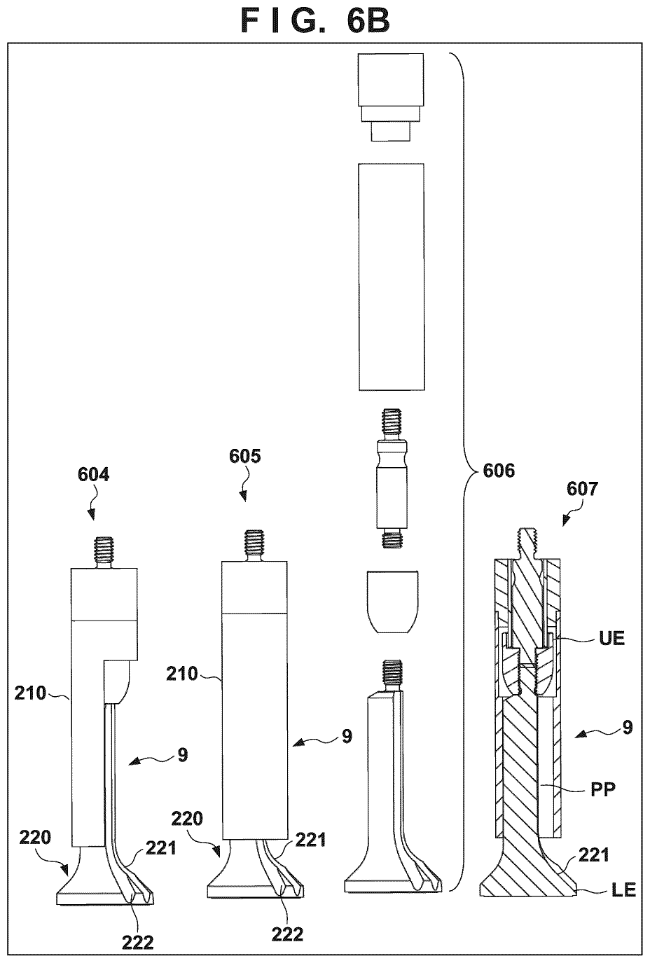

FIGS. 6A and 6B show the pouring nozzle 9 according to the fifth configuration example. Reference numeral 601 indicates a perspective view of the pouring nozzle 9 with a partially cutaway view of the cylindrical portion 210. Reference numeral 602 indicates a perspective view of the pouring nozzle 9. Reference numeral 603 indicates an exploded perspective views of the pouring nozzle 9. Reference numeral 604 indicates a side view of the pouring nozzle 9 with a partially cutaway view of the cylindrical portion 210. Reference numeral 605 indicates a side view of the pouring nozzle 9. Reference numeral 606 indicates an exploded side view of the pouring nozzle 9. Reference numeral 607 indicates a sectional view of the pouring nozzle 9. The pouring nozzle 9 can include the cylindrical member 210 and the guide 220. The guide 220 includes the guide surface 221. One portion of the guide surface 221 is arranged inside the cylindrical member 210, and another portion (lower portion) of the guide surface 221 projects to the lower side of the cylindrical member 210. The carbonated beverage poured from the pouring nozzle 9 runs down inside the cylindrical member 210 while being guided by the guide surface 221. The guide surface 221 includes the upper end UE and the lower end LE and can be formed such that the tilt becomes moderate from the position PP between the upper end UE and the lower end LE to the lower end LE. The tilt can smoothly change. The guide surface 221 can be formed such that the carbonated beverage that has passed the lower end LE spreads in a fan shape. In another viewpoint, the guide surface 221 can be formed such that the carbonated beverage that has passed the lower end LE radially spreads. The guide surface 221 can include the plurality of grooves 222 provided to control the flow of the carbonated beverage. The width of the plurality of grooves in the direction orthogonal to the axial direction of the cylindrical member 210 falls within the range of, for example, 1 to 5 mm, and preferably within the range of 2 to 3 mm. As exemplified by 607, the channel of the carbonated beverage inside the cylindrical member 210 can be defined by a portion of the inner surface of the cylindrical member 210 and the guide surface 221 on a cross section orthogonal to the axial direction of the cylindrical member 210. On the cross section, the other portion of the inner surface of the cylindrical member 210 and the guide 220 can contact.

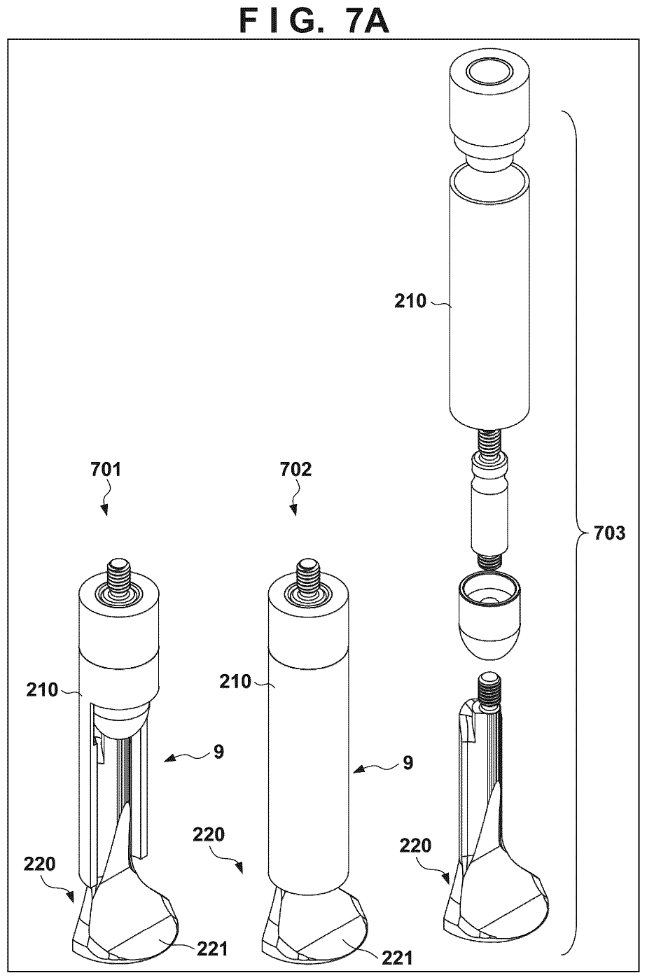

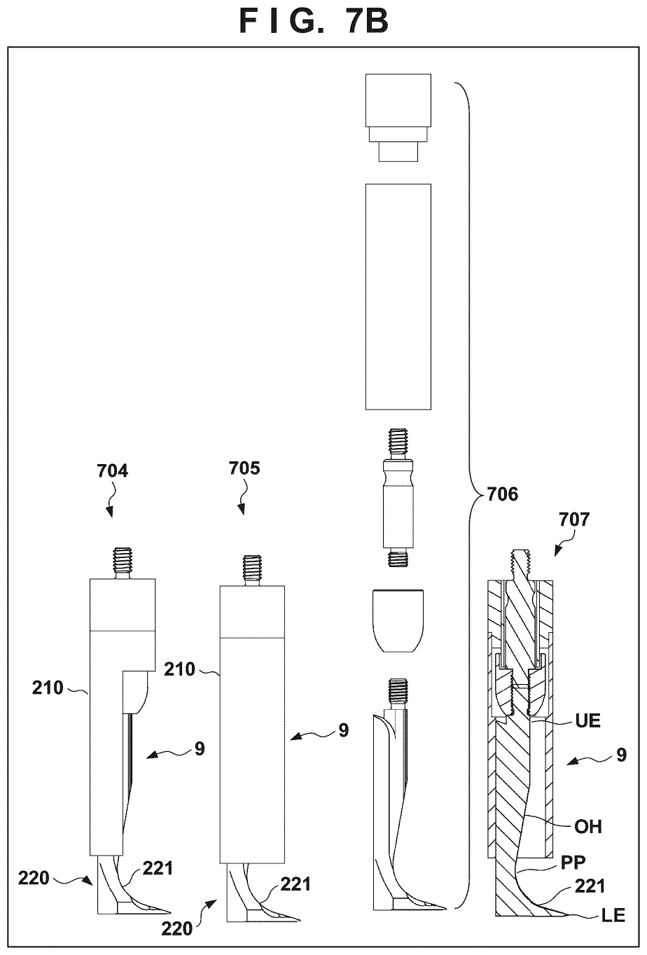

FIGS. 7A and 7B show the pouring nozzle 9 according to the sixth configuration example. Reference numeral 701 indicates a perspective view of the pouring nozzle 9 with a partially cutaway view of the cylindrical portion 210. Reference numeral 702 indicates a perspective view of the pouring nozzle 9. Reference numeral 703 indicates an exploded perspective views of the pouring nozzle 9. Reference numeral 704 indicates a side view of the pouring nozzle 9 with a partially cutaway view of the cylindrical portion 210. Reference numeral 705 indicates a side view of the pouring nozzle 9. Reference numeral 706 indicates an exploded side view of the pouring nozzle 9. Reference numeral 707 indicates a sectional view of the pouring nozzle 9. The pouring nozzle 9 can include the cylindrical member 210 and the guide 220. The guide 220 includes the guide surface 221. One portion of the guide surface 221 is arranged inside the cylindrical member 210, and another portion (lower portion) of the guide surface 221 projects to the lower side of the cylindrical member 210. The carbonated beverage poured from the pouring nozzle 9 runs down inside the cylindrical member 210 while being guided by the guide surface 221. The guide surface 221 includes the upper end UE and the lower end LE and can be formed such that the tilt becomes moderate from the position PP between the upper end UE and the lower end LE to the lower end LE. The tilt can smoothly change. The guide surface 221 can be formed such that the carbonated beverage that has passed the lower end LE spreads in a fan shape. In another viewpoint, the guide surface 221 can be formed such that the carbonated beverage that has passed the lower end LE radially spreads. In the sixth configuration example, no grooves are provided in the guide surface 221. The guide surface 221 can include the overhang surface OH in the section from the upper end UE to the position PP between the upper end UE and the lower end LE. The overhang surface OH is advantageous for controlling the flow velocity of the carbonated beverage. As exemplified by 707, the channel of the carbonated beverage inside the cylindrical member 210 can be defined by a portion of the inner surface of the cylindrical member 210 and the guide surface 221 on a cross section orthogonal to the axial direction of the cylindrical member 210. On the cross section, the other portion of the inner surface of the cylindrical member 210 and the guide 220 can contact.

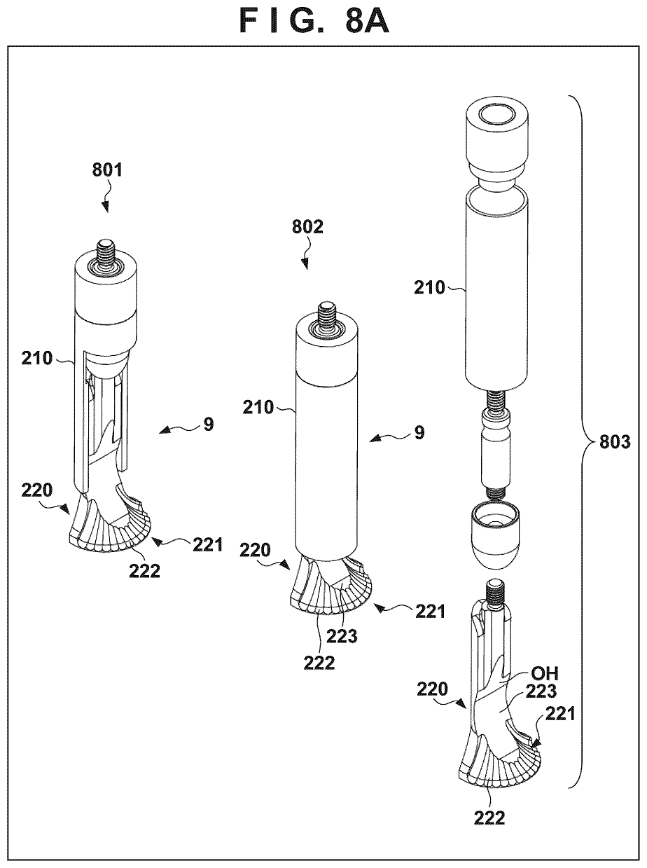

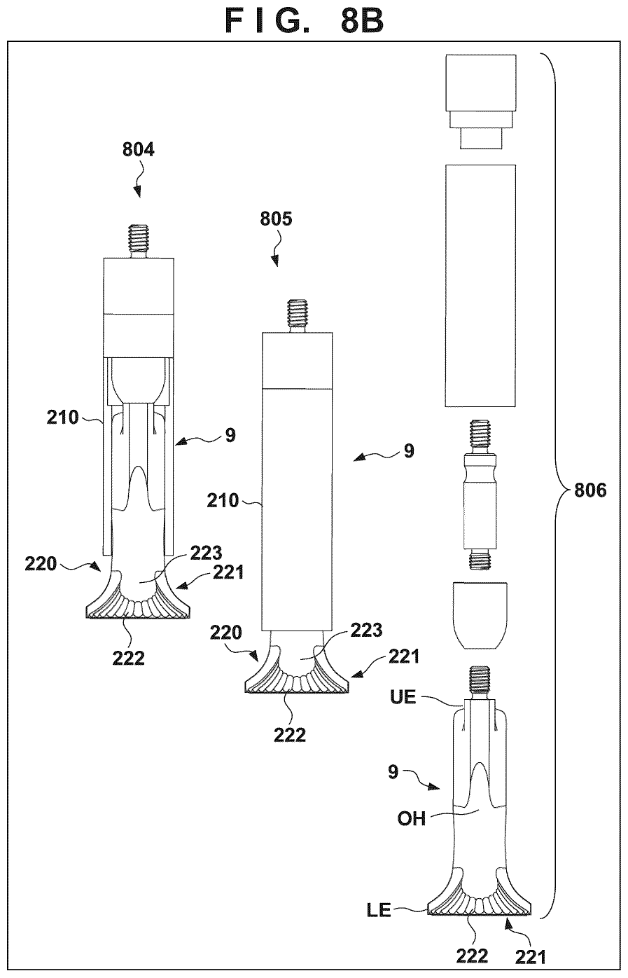

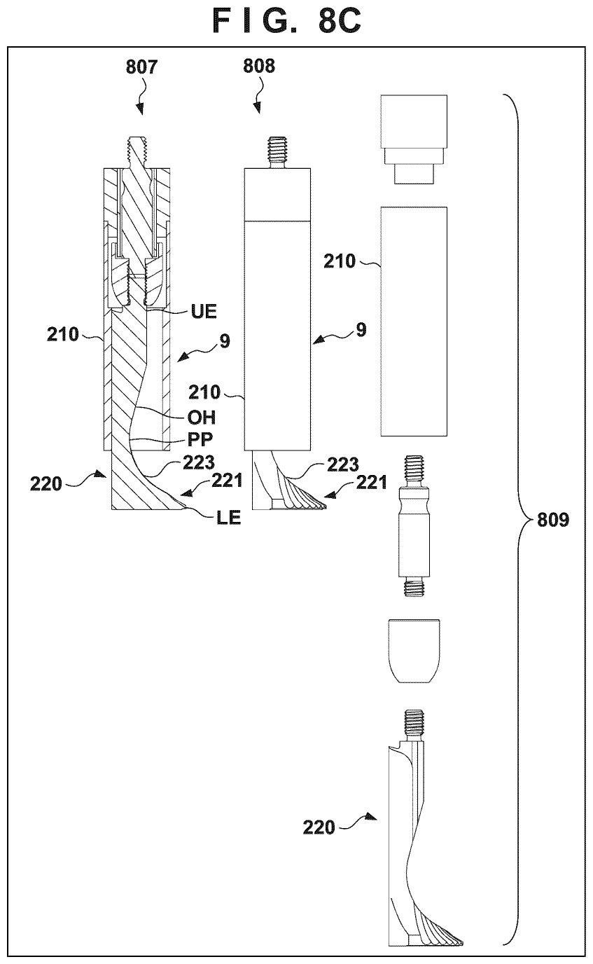

FIGS. 8A, 8B, and 8C show the pouring nozzle 9 according to the seventh configuration example. Reference numeral 801 indicates a perspective view of the pouring nozzle 9 with a partially cutaway view of the cylindrical portion 210. Reference numeral 802 indicates a perspective view of the pouring nozzle 9. Reference numeral 803 indicates an exploded perspective view of the pouring nozzle 9. Reference numeral 804 indicates a front view of the pouring nozzle 9 with a partially cutaway view of the cylindrical portion 210. Reference numeral 805 indicates a front view of the pouring nozzle 9. Reference numeral 806 indicates an exploded front view of the pouring nozzle 9. Reference numeral 807 indicates a sectional view of the pouring nozzle 9. Reference numeral 808 indicates a side view of the pouring nozzle 9. Reference numeral 809 indicates an exploded side view of the pouring nozzle 9. The pouring nozzle 9 can include the cylindrical member 210 and the guide 220. The guide 220 includes the guide surface 221. One portion of the guide surface 221 is arranged inside the cylindrical member 210, and another portion (lower portion) of the guide surface 221 projects to the lower side of the cylindrical member 210. The carbonated beverage poured from the pouring nozzle 9 runs down inside the cylindrical member 210 while being guided by the guide surface 221. The guide surface 221 includes the upper end UE and the lower end LE and can be formed such that the tilt becomes moderate from the position PP between the upper end UE and the lower end LE to the lower end LE. The tilt can smoothly change. The guide surface 221 can be formed such that the carbonated beverage that has passed the lower end LE spreads in a fan shape. In another viewpoint, the guide surface 221 can be formed such that the carbonated beverage that has passed the lower end LE radially spreads. The guide surface 221 can include the plurality of grooves 222 provided to control the flow of the carbonated beverage. The width of the plurality of grooves in the direction orthogonal to the axial direction of the cylindrical member 210 falls within the range of, for example, 1 to 5 mm, and preferably within the range of 2 to 3 mm. The guide surface 221 includes the first region 223 without grooves, and the second region from the first region 223 to the lower end of the guide surface 221, and the plurality of grooves 222 can be provided in the second region. As exemplified by 807, the channel of the carbonated beverage inside the cylindrical member 210 can be defined by a portion of the inner surface of the cylindrical member 210 and the guide surface 221 on a cross section orthogonal to the axial direction of the cylindrical member 210. On the cross section, the other portion of the inner surface of the cylindrical member 210 and the guide 220 can contact. The guide surface 221 can include the overhang surface OH in the section from the upper end UE to the position PP between the upper end UE and the lower end LE. The overhang surface OH is advantageous for controlling the flow velocity of the carbonated beverage.

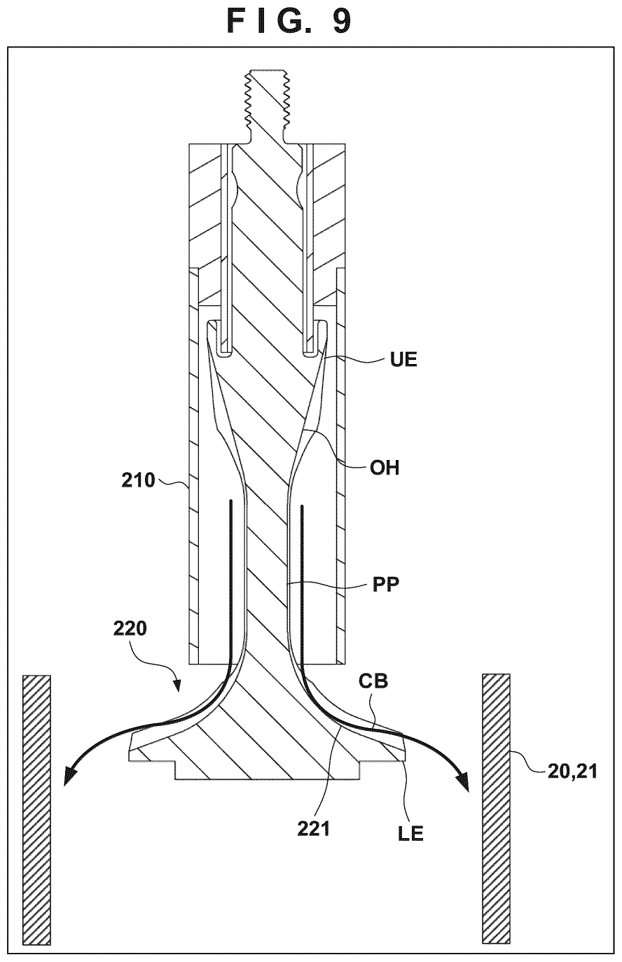

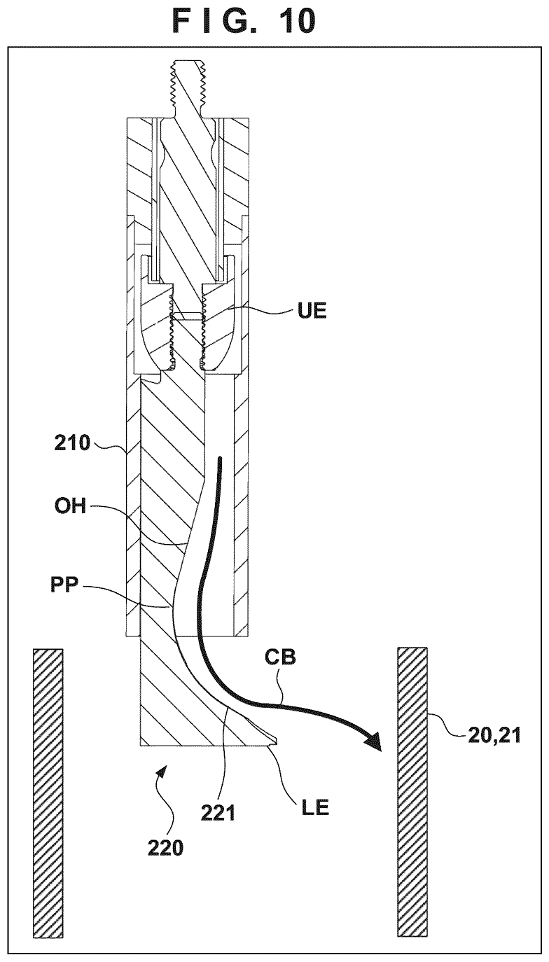

FIGS. 9 and 10 each schematically show the effect of providing the guide surface 221, like the pouring nozzle 9 according to this embodiment. As described above, the guide surface 221 can be configured such that the tilt becomes moderate from the position between the upper end UE of the guide surface 221 and the lower end LE of the guide surface 221 to the lower end LE. A component in a direction to the inner surface of the beverage container 20 or the mouth portion 21 is thus given to the flow of the carbonated beverage CB supplied from the main body portion 15. In other words, the guide surface 221 can give a component in the horizontal direction to the flow of the carbonated beverage CB supplied from the main body portion 15. Thus, the carbonated beverage CB supplied from the main body portion 15 can be discharged from the pouring nozzle 9 in an oblique downward direction or the horizontal direction toward the inner surface of the beverage container 20 or the mouth portion 21. Hence, according to this embodiment, it is possible to effectively suppress release of the carbon dioxide gas from the carbonated beverage CB, that is, lowering of the GV value, as compared to a case where the carbonated beverage CB is discharged in the vertical direction from the pouring nozzle to the bottom portion of the beverage container 20.

In all the above-described configuration examples, it was confirmed that the GV value of a carbonated beverage poured by the beverage server 100 to the beverage container exceeded 4.0 after pouring. Particularly, in first to third, fifth, and sixth configuration examples, it was confirmed that the GV value of a carbonated beverage poured by the beverage server 100 to the beverage container exceeded 5.0 after pouring. Also, in the seventh configuration example, it was confirmed that the GV value of a carbonated beverage poured from the beverage server 100 to the beverage container exceeded 5.4 after pouring.

The invention is not limited to the foregoing embodiments, and various variations/changes are possible within the spirit of the invention.

### REFERENCE SIGNS LIST

1 . . . filter, 2 . . . channel, 3 . . . valve, 4 . . . pump, 5 . . . cooling coil, 6 . . . channel, 7 . . . cooling coil, 8 . . . pouring head, 9 . . . pouring nozzle, 10 . . . positioning member, 11 . . . carbon dioxide gas supply source, 12 . . . pressure reduction valve, 13 . . . adding unit (carbonator), 14 . . . cooling tank, 15 . . . main body, 16 . . . channel, 17 . . . coolant, 100 . . . beverage server, 20 . . . beverage container, 21 . . . mouth portion, 210 . . . cylindrical portion, 220 . . . guide, 221 . . . guide surface, 222 . . . groove, 223 . . . first region, UE . . . upper end, LE . . . lower end, PP . . . position between upper end and lower end, OH . . . overhang surface

What is claimed is:

1. A beverage server configured to pour a carbonated beverage to a beverage container, comprising:
a supply source configured to supply the carbonated beverage; and
a pouring nozzle configured to pour the carbonated beverage supplied from the supply source to the beverage container,
wherein the pouring nozzle includes a cylindrical member, and a guide including a guide surface whose one portion is arranged inside the cylindrical member and whose another portion projects to a lower side of the cylindrical member,
the carbonated beverage runs down inside the cylindrical member while being guided by the guide surface, and
the guide surface includes an upper end and a lower end and is formed such that a tilt becomes moderate from a position between the upper end and the lower end to the lower end.

2. The beverage server according to claim 1, wherein
the tilt smoothly changes.

3. The beverage server according to claim 1, wherein
the guide surface is formed such that the carbonated beverage that has passed the lower end spreads in a fan shape.

4. The beverage server according to claim 1, wherein
the guide surface is formed such that the carbonated beverage that has passed the lower end radially spreads.

5. The beverage server according to claim 3, wherein
the guide surface includes a plurality of grooves provided to control a flow of the carbonated beverage.

6. The beverage server according to claim 5, wherein
the guide surface includes a first region without grooves, and a second region from the first region to the lower end, and the plurality of grooves are provided in the second region.

7. The beverage server according to claim 5, wherein
a width of the plurality of grooves in a direction orthogonal to an axial direction of the cylindrical member falls within a range of 1 to 5 mm.

8. The beverage server according to claim 5, wherein
the guide surface includes an overhang surface in a section from the upper end to the position between the upper end and the lower end.

9. The beverage server according to claim 8, wherein
the overhang surface is wholly located inside the cylindrical member.

10. The beverage server according to claim 1, wherein
a channel of the carbonated beverage inside the cylindrical member is defined by a portion of an inner surface of the cylindrical member and the guide surface on a cross section orthogonal to the axial direction of the cylindrical member.

11. The beverage server according to claim 10, wherein
on the cross section, the other portion of the inner surface of the cylindrical member and the guide contact.

12. The beverage server according to claim 1, wherein
the guide surface includes an overhang surface in a section from the upper end to the position between the upper end and the lower end.

13. The beverage server according to claim 1, wherein
a maximum size of the lower end of the guide surface in a direction along a plane orthogonal to the axial direction of the cylindrical member is larger than a maximum size of the cylindrical member in the direction along the plane.

14. A pouring nozzle configured to pour, to a beverage container, a carbonated beverage supplied from a supply source configured to supply the carbonated beverage, wherein
the pouring nozzle includes a cylindrical member, and a guide including a guide surface whose one portion is arranged inside the cylindrical member and whose another portion projects to a lower side of the cylindrical member,
the carbonated beverage runs down inside the cylindrical member while being guided by the guide surface, and
the guide surface includes an upper end and a lower end and is formed such that a tilt becomes moderate from a position between the upper end and the lower end to the lower end.
